(19) United States
(12) Patent Application Publication
(10) Pub. No.: US 2004/0097236 A1
(43) Pub. Date: May 20, 2004

(54) Mobile wireless network and method

(76) Inventors: Wayne Harvey Knox, Pittsford, NY (US); Anjur Sundaresan Krishnakumar, Rocky Hill, NJ (US)

Correspondence Address: Ms. Susan Curry, Lucent Technologies, Inc., Room 3J-220, 101 Crawfords Corner Road, Holmdel, NJ, 07733-3030, US

(21) Appl. No.: 10/300,943

(22) Filed: Nov. 20, 2002

(51) Int. Cl. H04Q 7/20; H04M 1/00

(52) U.S. Cl. 455/445; 455/560

(57) ABSTRACT

A communication architecture switch and method which provide a switch capable of connecting a mobile terminal to one router port of a plurality of router ports substantially independent of a connection path between the mobile terminal and the one router port for a session duration. The connection to the same router port for the duration of a session allows the router to operate as if the mobile terminal had a unique address instead of being a mobile terminal with a variable address. This simplifies the router and other network layer element as the need for a Mobile IP Protocol at the network level is obviated.

### FIELD OF THE INVENTION

The present invention relates generally to a wireless mobile network and method for managing a wireless mobile network, and more particularly to a wireless mobile network switch that allows movement across subnetworks by a mobile terminal with an address that may be varied and a method for managing a wireless mobile network that allows movement across subnetworks by an end terminal with an address that may be varied.

### BACKGROUND OF THE INVENTION

Wireless mobile networks allow terminals to move across subnetworks. However, routers base their routing decisions on the subnetwork address instead of the complete address. Thus, a signal will be misdirected and will not reach a mobile terminal when the mobile terminal moves between subnetworks. To overcome this problem, mobile internet protocol (IP) protocols that allow a unique IP address to move between subnetworks have been implemented at the network level. Unfortunately, this burdens the network layer with class-of-service (CoS) support, quality-of-service (QoS) support and additional overhead required to maintain Mobile IP. Additionally, the complexity of a mobile IP protocol increases costs, increases the complexity of network management, and complicates physical security, maintenance and upgrades. Accordingly, there is a strong need in the art for a wireless mobile network that demands less of the network layer and has reduced complexity, lower cost, simpler network management, and easier physical security, maintenance and upgrades.

### SUMMARY OF THE INVENTION

The present invention provides a mobile wireless network and method of operating the mobile wireless network which manages the mobility at the medium access control (MAC) layer. This reduces complexity, lowers cost, simplifies network management and simplifies physical security, maintenance and upgrades.

An aspect of the invention is to provide a communication architecture switch including a switch capable of connecting a mobile terminal to one router port of a plurality of router ports substantially independent of a connection path between the mobile terminal and the one router port for a session duration.

Another aspect of the invention is to provide a communication architecture switching method including connecting a mobile terminal to one router port of a plurality of router ports independent of a connection path between the mobile terminal and the one router port for a session duration.

Another aspect of the invention is to provide a communication architecture switch including a media access control switch that associates a mobile terminal to a single router network port for a session duration. The media access control switch adding media access routing information for the mobile terminal to a signal received at the single router network port.

Another aspect of the invention is to provide a method of operating a communication architecture switch including associating a mobile terminal to a single router network port for a session duration and inserting media access routing information for the mobile terminal into a signal received at the single router network port.

Another aspect of the invention is to provide a communication architecture switch including a media access control switch that associates a mobile terminal to a single router network port for a session duration, the single network port capable of being associated to another terminal after the session duration ends. The media access control switch directs transmissions to and receives transmissions from a plurality of radio access ports and a network level internet protocol address of the mobile terminal does not change when the mobile terminal moves from a coverage area of one of the plurality of radio access ports to a coverage area of another of the radio access ports.

### BRIEF DESCRIPTION OF THE DRAWINGS

FIG. 1 shows an exemplary distribution architecture according to an embodiment of the present invention;

FIG. 2 shows a block diagram of an exemplary radio excess port according to an embodiment of the present invention;

FIG. 3 shows part of an exemplary optical signal processor that is converting radio signals into optical signals according to an embodiment of the present invention;

FIG. 4 shows part of an exemplary optical signal processor that is converting optical signals into radio signals according to an embodiment of the present invention; and

FIG. 5 shows an exemplary flowchart that illustrates the operation of the switch according to an embodiment of the present invention.

### DETAILED DESCRIPTION

Embodiments of the present invention will now be described with reference to the accompanying figures, where like reference numerals designate like parts.

Embodiments of the present invention use the media access control (MAC) layer switch for mobility management by having the same network port serve a given mobile terminal for a session duration. This makes the subnetwork logically based instead of being location based. Thus, a mobile terminal may move anywhere within a coverage area without changing its IP address and without the need for re-registration. Exemplary advantages, features and alternatives are discussed of the present invention are discussed in greater detail below.

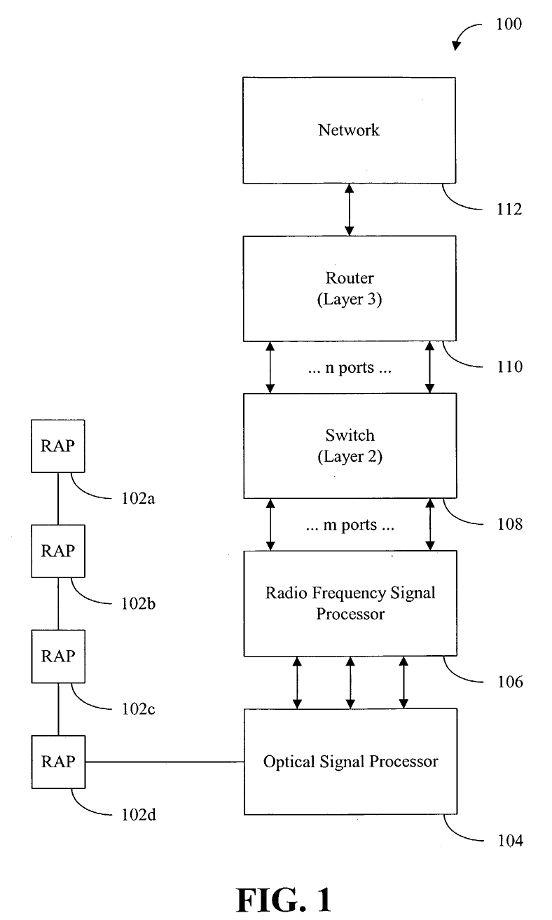

FIG. 1 shows an exemplary distribution architecture 100 according to an embodiment of the present invention. The distribution architecture 100 may be part of a cellular telephony network, a cellular data network or an indoor wireless data network (e.g., IEEE 802.11) and includes a plurality of radio access ports (RAP) 102a, 102b 102c, 102d, an optical signal processor (OSP) 104, a radio frequency signal processor 106, a switch 108, a router 110 and a network 112. The RAPs 102a, 102b, 102c, 102d convert the radio frequency signals from one or more terminals into optical signals for transmission to the OSP 104 and convert the optical signals from the OSP 104 into radio frequency signals for transmission to the one or more terminals. The RAPs 102a, 102b, 102c, 102d may also perform multiplexing functions in both the radio and the optical domains.

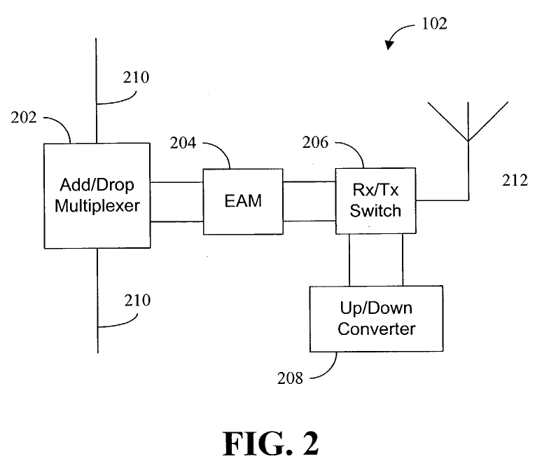

FIG. 2 shows a block diagram of exemplary RAP 102 according to an embodiment of the present invention. The RAP 102 includes an add-drop multiplexer 202, an electro-absorption modulator (EAM) 204, a receive/transmit (Rx/Tx) switch 206, an up/down converter 208, fiber optic cables 210 and an antenna 212. The add/drop multiplexer 202 operates in the drop mode when the RAP 102 is receiving information from the fiber optic cables 210 and operates in the add mode when the RAP 102 is delivering information to the fiber optic cable 210. Information is extracted from the fiber optic cable 210 when the EAM 204 converts an optical signal into an electrical signal. The electrical signal is then input into the Rx/Tx switch 206 which directs the signal into an up/down converter 208. The up/down converter 208 shifts the frequency of the signal up or down so as to avoid overlapping signals with other RAPs 102 and to provide a signal at a frequency usable by the appropriate end terminal.

The RAP 102 is also able to transfer a signal received from an end terminal for transmission to the fiber optic cable 210 in the add mode. Transfer of a signal received from an end terminal to the fiber optic cable 210 begins by the antenna 212 receiving a signal which is then input into the Rx/Tx switch 206. The up/down converter 208 shifts the frequency of the signal up or down so as to be at a frequency usable by the distribution architecture 100. The electrical signal is then input into the Rx/Tx switch 206 which directs the signal into EAM 204. The light separated from the fiber optic cable 210 by the add/drop multiplexer 202 is also directed into the EAM 204. This encodes the electrical signal into the light because the amount of light absorption is proportional to the strength of the electrical signal applied to the EAM 204.

In the radio frequency domain, a modulator is used to shift the frequency band up or down so that the same radio frequency channel from different access ports may be carried on the same optical wavelength. In the optical domain, wavelength division multiplexing is used to increase the number of access ports that may be supported. The increased number of access ports may be facilitated through the use of add-drop optical multiplexers. Alternatively, the add-drop multiplexers may be active or passive, and may be otherwise reconfigured.

The RAPs 102a, 102b, 102c, 102d are connected to the OSP 104 by fiber optic cable 210. A RAP 102 extracts and re-inserts a specified wavelength from the fiber optical cable 210 with a pass through the EAM 204. A RAP 102 may also provide frequency division multiplexing by shifting a signal up or down into a specified band. Optionally, a RAP 102 may include amplifiers for increased transmission power and coverage area. The connection for the RAPs 102a, 102b, 102c, 102d may be direct or may include additional elements such as relay units, splitting/combining elements or other elements. The connection may be made in series, in parallel or a combination of in series and in parallel.

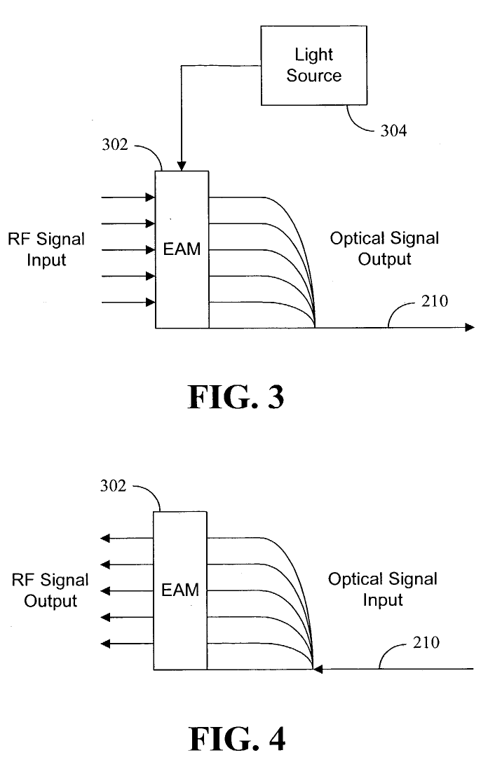

FIG. 3 and FIG. 4 show two parts of an exemplary OSP 104. FIG. 3 shows the part of an exemplary OSP 104 that is converting radio signals into optical signals according to an embodiment of the present invention while FIG. 4 shows the part of an exemplary OSP 104 that is converting optical signals into radio signals according to an embodiment of the present invention. The part of the OSP 104 shown in FIG. 3 includes an EAM 302 and a light source 304. FIG. 3 and FIG. 4 are structurally similar except FIG. 4 does not require the use of a light source since light is being converted into electrical signals instead of visa versa.

The EAM 302 converts radio frequency signals to optical signals and visa versa. The radio frequency signals are converted into optical signals by applying an electrical signal from the radio frequency signal processor 106 to the EAM 302 while light from a light source 304 is passed through the EAM 302. This encodes the electrical signal from the radio frequency signal processor 106 into the light passing through the EAM 302 since the amount of light absorption is proportional to the strength of the applied electrical signal. Conversely, optical signals are converted into electrical signals by the EAM 302 through voltage generation. The voltage is generated by absorption of all or some of the light from the RAPs 102a, 102b, 102c, 102d. This is possible because electro-absorption generates a voltage proportional to the intensity of light passing through the EAM 302.

The radio frequency signal processor 106 can be a radio modem, a modem that performs frequency band shifting, or any other appropriate modulator/demodulator. The modem functions of the radio frequency signal processor 106 are those performed by conventional modems. The frequency band shifting of the incoming and outgoing signals by the radio frequency signal processor 106 may be integrated with the up/down conversion of modem operation by the appropriate adjustment of a local oscillator frequency. Alternatively, the radio frequency signal processor 106 may be a separate unit or combined into either the OSP 104 or the switch 108.

The switch 108 is connected between the radio frequency signal processor 106 and the router 110. The switch 108 is typically at the layer two level and the router 110 is typically at the layer three level. However, the layer number may be different for differing architectures. Layer two is commonly known as the MAC layer and layer three is commonly called the network layer.

The switch 108 has a global view of the entire coverage area of the RAPs 102a, 102b, 102c, 102d and performs mobility management. The switch 108 directs the traffic between the m radio frequency signal processor ports at the MAC layer and the n router ports at the network layer such that a given mobile terminal always appears on the same network port during a session. The switch 108 directs voice or data traffic such that the corresponding IP address always appears on the same network port. Thus, a mobile terminal may be assigned to the same network port for the duration of a session. This lets the network layer act as if the mobile terminal has no mobility since the mobility information is confined to the MAC layer. The absence of mobility information at the network level obviates the need for a mobile IP protocol at the network level which reduces the complexity and cost of the network level routers. Additionally, handling mobility management at the MAC level allows the physical security, maintenance and upgrades to be performed on the local switches 108 instead of on the routers 110. Thus, the physical security, maintenance and upgrades are simplified because the switches 108 may be located and secured on site.

In operation, the switch 108 dedicates a network port to a particular mobile terminal. This dedicated port is initially associated with one virtual access point (VAP) that is used to direct traffic to the mobile terminal with a unique identifier. The dedicated port may be reallocated to a different terminal at the end of a session which allows for the dynamic port allocation. The choice of which network port should be dedicated to a particular terminal may be determined according to any number of considerations including but not limited to load band balancing, security policy, required quality of service, or any other consideration.

The switch 108 may identify and track a terminal by updating a MAC layer routing table that associates ports, VAPs and terminals. For example, data is received from the network 112 and transmitted to the router 110. The router 110 uses the routing information to route the data to the dedicated port associated with the terminal. The switch 108 receives the data for the terminal and looks up the routing identifiers of the terminal. An exemplary identifier is (λ, f, c), where λ is the optical wavelength carrying the radio frequency signal, f is the center frequency of the radio frequency band and c the channel identification within the band, could be used as the identifier. Alternatively, other identifiers may also be used such as MAC address or other unique identifier of the terminal. The identifier may be encoded as a header by the switch 108 and controls the routing by the switch 108, the radio frequency signal processor 106 and the OSP 104. The switch 108 uses the identifier to directed traffic to the appropriate MAC layer port. The radio frequency signal processor 106 and the OSP 104 use the identifier to direct routing and select the frequency band. This header containing the identifier may be stripped off prior to the radio frequency signal being modulated or encoded upon an optical signal for transmission to the terminal via a RAP 102.

Another header may be added to the transmissions received from the terminal for transmission to the network 112. This header may include or consist of identifier information that is used to update the MAC layer routing table. This header may be complied and inserted into the transmission by the OSP 104 and/or radio frequency signal processor 106. For example, the OSP 104 may add identifier information as a header to the transmission transmitted to the radio frequency signal processor 106. The radio frequency signal processor 106 then may add additional identifier information to the header. Alternatively, the RAP 102 may add information to the header. This new header may be used to update the MAC layer routing table. When the terminal is mobile and moves between the coverage areas of different RAPs 102, the MAC address of the terminal will be seen on a new VAP in addition to the VAP currently serving the mobile terminal. The VAP information then may be used to update the MAC layer routing table of the switch 108. Lastly, the switch 108 may strip off the header since the header is not used by the network layer.

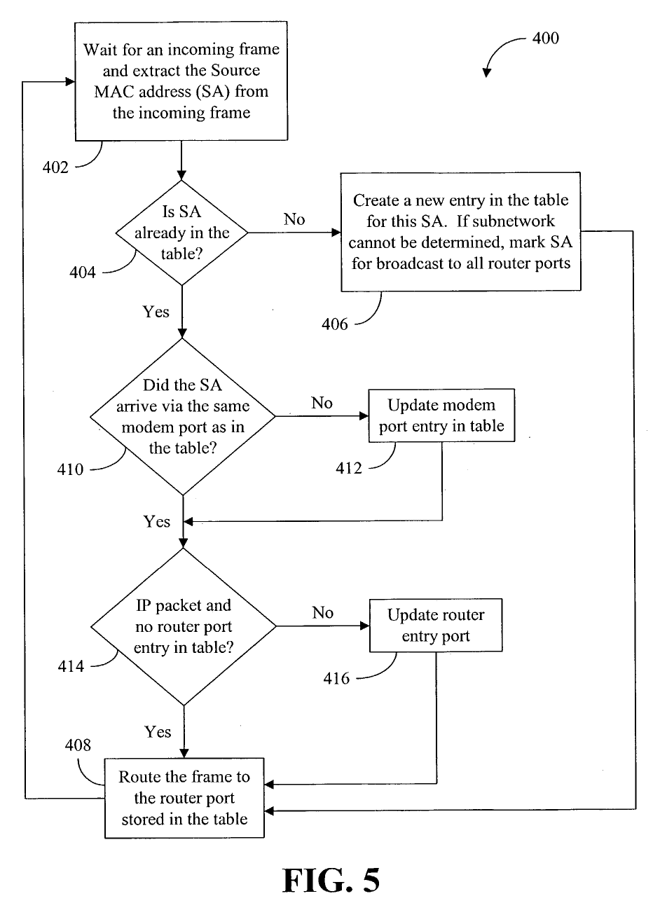

FIG. 5 shows an exemplary flowchart 400 that illustrates the operation of the switch 108 according to an embodiment of the present invention. Flowchart 400 begins at step 402 by having the switch 108 wait for an incoming frame and upon receipt of the incoming frame, the switch 108 extracts the Source MAC address (SA). Next, the switch 108 determines in step 404 whether the SA is already in the table. If the SA is not in the table, a new entry is created in step 406 for the SA. The SA is marked for broadcast to all router ports where the subnetwork cannot be determined in step 406. Next, the frame is routed in step 408 to the router port stored in the table and then returns to step 402 to wait for the next incoming frame.

If the SA is in the table at step 404, the switch 108 proceeds to step 410 and determines whether the SA arrived via the same modem port as already in the table. The modem port entry in the table is updated in step 412 when the SA arrived at a different modem port. The switch 108 then determines in step 414 whether there is an IP packet in the frame that has no router port entry in the table and when this condition is false the router port entry in the table is updated in step 416. Next, the frame is routed to the router port stored in the table in step 408 and then returns to step 402 to wait for the next incoming frame.

An exemplary MAC frame may include a MAC header, an IP packet, and other information. The MAC header may include a destination address, a source address (e.g., the SA), and other information. The IP packet may include an IP header and other information. Components of the MAC frame may be included into the table. For example, when a mobile terminal becomes active and registers with the network, a table entry may be created. The table entry may have any appropriate format. For example, the format may be:

Entry identifier, MAC address, IP address, modem port number, additional information. The additional information may be any kind of useful information including but not limited to the type of service, priority and/or user profile. The additional information may be used for network management, resource management or any other use.

The router 110 and network 112 do not require any special feature or programming to handle mobility since the mobility information is confined to the MAC layer and the network layer operates as if all of the terminals are non-mobile. This advantageously allows conventional IP routers and other network layer hardware to be used with mobile terminals without retrofitting either the network layer hardware and network software.

A more detailed explanation of the operation and construction of an EAM 204 as part of a RAP 102 or an EAM 302 as part of an OSP 104 can be found in U.S. Pat. No. 5,949,564, which is incorporated by reference in its entirety. Alternatively, any operation or construction of EAMs may be used provided the distribution architecture 100 is properly configured.

RAPs 102 are used to couple radio signals into the distribution architecture 100 from the terminals. Alternatively, the radio signal may be processed as electrical signals instead of being converted into optical signals. Another alternative is where the end terminal produces an optical signal, such as produced by an infrared light emitting diode, which is received and converted by a photodetector instead of an antenna 212.

Although several embodiments of the present invention and its advantages have been described in detail, it should be understood that changes, substitutions, transformations, modifications, variations, permutations and alterations may be made therein without departing from the teachings of the present invention.

We claim:

1. A communication architecture switch comprising:
a switch capable of connecting a mobile terminal to one router port of a plurality of router ports substantially independent of a connection path between the mobile terminal and the one router port for a session duration.

2. The switch of claim 1, wherein the connection path may be along any of a plurality of radio access ports.

3. The switch of claim 1, wherein the plurality of router ports are a plurality of layer three router ports.

4. The switch of claim 1, wherein the switch is a layer two switch.

5. The switch of claim 1, wherein an address of the mobile terminal may vary during a connection session.

6. The switch of claim 5, wherein the address of the mobile terminal appears fixed at the router address level.

7. The switch of claim 5, wherein the address is a dynamically assigned address.

8. The switch of claim 1, wherein the switch tabulates mobility information for the mobile terminal and provides mobility management.

9. The switch of claim 1, wherein the mobile terminal may be connected to different router ports during different sessions.

10. A communication architecture switching method comprising:
connecting a mobile terminal to one router port of a plurality of router ports independent of a connection path between the mobile terminal and the one router port for a session duration.

11. The method of claim 10, wherein the connection path may be along any of a plurality of radio access ports.

12. The method of claim 10, wherein the plurality of router ports are a plurality of layer three router ports.

13. The method of claim 10, wherein the connecting a mobile terminal to one router port of a plurality of router ports is performed by a layer two switch.

14. The method of claim 10, wherein an address of the mobile terminal may vary during a connection session.

15. The method of claim 14, wherein the address of the mobile terminal appears fixed at the router address level.

16. The method of claim 14, wherein the address is a dynamically assigned address.

17. The method of claim 10, wherein mobility information for the mobile terminal is tabulated at a media access control level and mobility management is provided at the media access control level.

18. The method of claim 10, wherein the connecting the mobile terminal to the one router port may connect the mobile terminal to different router ports during different sessions.

19. A communication architecture switch comprising:
a media access control switch that associates a mobile terminal to a single router network port for a session duration,
wherein the media access control switch adds media access routing information for the mobile terminal to a signal received at the single router network port.

20. The switch of claim 19, wherein an address of the mobile terminal changes during the session duration.

21. The switch of claim 20, wherein the address of the mobile terminal appears fixed at the single router network port.

22. The switch of claim 21, wherein single router network port can be used by another terminal after the session duration concludes.

23. The switch of claim 19, wherein the switch tabulates mobility information for the mobile terminal and provides mobility management.

24. A method of operating a communication architecture switch comprising:
associating a mobile terminal to a single router network port for a session duration,
inserting media access routing information for the mobile terminal into a signal received at the single router network port.

25. The method of claim 24, wherein an address of the mobile terminal changes during the session duration.

26. The method of claim 25, wherein the address of the mobile terminal appears fixed at the single router network port.

27. The method of claim 26, wherein the single router network port can be used by another terminal after the session duration concludes.

28. The method of claim 24, further comprising tabulating mobility information for the mobile terminal.

29. A communication architecture switch comprising:
a media access control switch that associates a mobile terminal to a single router network port for a session duration, the single network port capable of being associated to another terminal after the session duration ends,
wherein the media access control switch directs transmissions to and receives transmissions from a plurality of radio access ports; and
wherein a network level internet protocol address of the mobile terminal does not change when the mobile terminal moves from a coverage area of one of the plurality of radio access ports to a coverage area of another of the radio access ports.

30. The switch of claim 29, wherein the media access control switch tabulates mobility information for the mobile terminal and provides mobility management.
